(19) United States
(12) Patent Application Publication
(10) Pub. No.: US 2023/0089823 A1
(43) Pub. Date: Mar. 23, 2023

(54) MOTOR WITH ELECTROMAGNETIC BRAKE

(71) Applicant: FANUC CORPORATION, Yamanashi (JP)

(72) Inventor: Hidetoshi UEMATSU, Yamanashi (JP)

(73) Assignee: FANUC CORPORATION, Yamanashi (JP)

(21) Appl. No.: 17/905,348

(22) PCT Filed: Jun. 21, 2021
(86) PCT No.: PCT/JP2021/023315

§ 371 Date: Aug. 31, 2022

(30) Foreign Application Priority Data
Jun. 25, 2020 (JP) 2020-109631

(51) Int. Cl. H02K 7/102; H02K 7/08; H02K 11/21

(52) U.S. Cl. CPC H02K 7/1025; H02K 7/083; H02K 11/21

(57) ABSTRACT

Easily suppress the adherence of metal powder to a motor shaft while suppressing costs. A motor with an electromagnetic brake 1 having: a motor 10; a motor shaft 20 rotated by the motor 10; a bearing 31 that supports the motor shaft 20 to be able to rotate; an electromagnetic brake 40 that brakes the rotation of the motor 10; and an encoder 50 that measures the rotation angle of the motor 10, wherein the bearing 31 is arranged farther to the motor 10 side than the electromagnetic brake 40 in the axial direction of the motor shaft 20, and when the maximum value of the magnetic flux density in the magnetic flux flowing in the electromagnetic brake 40 is A teslas, the electromagnetic brake 40 and the motor shaft 20 are arranged separated by A × 0.3 mm or greater.

### TECHNICAL FIELD

The present invention relates to a motor with an electromagnetic brake.

### BACKGROUND ART

Conventionally, a motor of a type in which an encoder is integrally coupled to a motor shaft, and an electromagnetic brake brakes rotation of the motor shaft when the motor stops has been used. In this type of a motor with an electromagnetic brake, when a coil of the electromagnetic brake is energized, magnetic flux flows through a bearing to a motor shaft made of a magnetic material, thereby causing an issue that metal powder generated in the motor or the electromagnetic brake during rotation of the motor adheres to the motor shaft. Patent Document 1 discloses a motor with an electromagnetic brake in which a portion of a motor shaft corresponding to the electromagnetic brake is made of a non-magnetic material.
Patent Document 1: Japanese Unexamined Patent Application, Publication No. H5-111213

### DISCLOSURE OF THE INVENTION

### Problems to be Solved by the Invention

According to the configuration disclosed in Patent Document 1, since it is difficult for magnetic flux to flow from the electromagnetic brake to the non-magnetic material, it is assumed that adhesion of metal powder to a portion of the motor shaft made of a magnetic material is suppressed. However, it is costly to firmly couple shaft members made of dissimilar materials such as a non-magnetic material and a magnetic material, and it is difficult to concentrically couple them with high accuracy because distortion is likely to occur. Therefore, a technology capable of easily suppressing adhesion of metal powder to a motor shaft while minimizing cost has been awaited.

### Means for Solving the Problems

A motor with an electromagnetic brake according to one aspect of the present disclosure includes a motor, a motor shaft configured to be rotated by the motor, a bearing configured to rotatably support the motor shaft, an electromagnetic brake configured to brake rotation of the motor, and an encoder configured to measure a rotation angle of the motor. The bearing is arranged closer to the motor than the electromagnetic brake in an axial direction of the motor shaft. When a maximum value of a magnetic flux density in magnetic flux flowing through the electromagnetic brake is A tesla, a portion of the electromagnetic brake through which the magnetic flux flows and the motor shaft are arranged apart from each other by A ×0.3 mm or more.

### Effects of the Invention

According to one aspect, it is possible to easily suppress adhesion of metal powder to a motor shaft while minimizing cost.

### BRIEF DESCRIPTION OF THE DRAWINGS

FIG. 1 is a sectional view schematically showing a motor with an electromagnetic brake according to an embodiment of the present disclosure;

FIG. 2 is an enlarged view of a portion indicated by II in FIG. 1;

FIG. 3 is a diagram schematically showing the electromagnetic brake of the embodiment as a simple two-dimensional magnetic circuit to confirm leakage magnetic flux of the embodiment;

FIG. 4 is a diagram showing a state of leakage magnetic flux when the inter-axis distance G shown in FIG. 3 is 2 mm;

FIG. 5 is a diagram showing a state of leakage magnetic flux when the inter-axis distance G shown in FIG. 3 is 0.2 mm; and

FIG. 6 is a graph showing the relationship between the inter-axis distance G (mm) shown in FIG. 3 and a leakage magnetic flux density (T).

### PREFERRED MODE FOR CARRYING OUT THE INVENTION

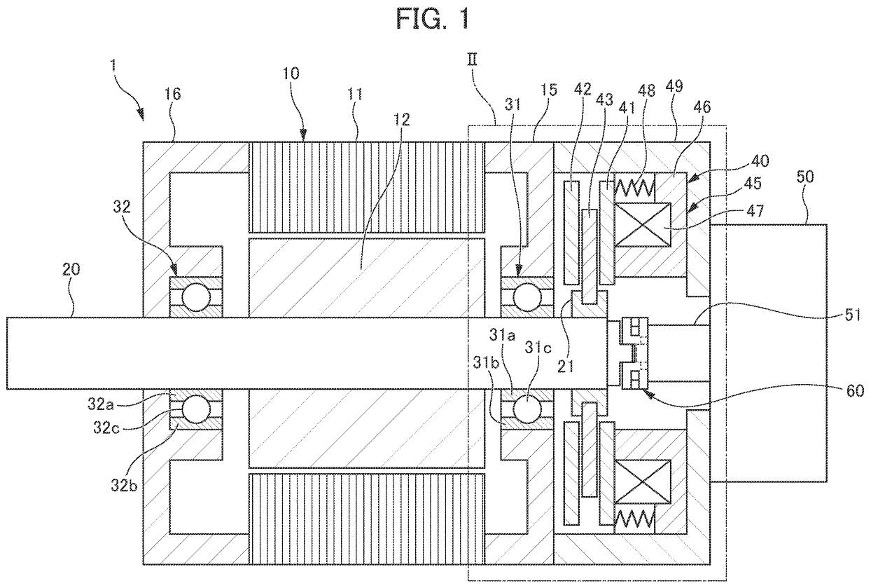

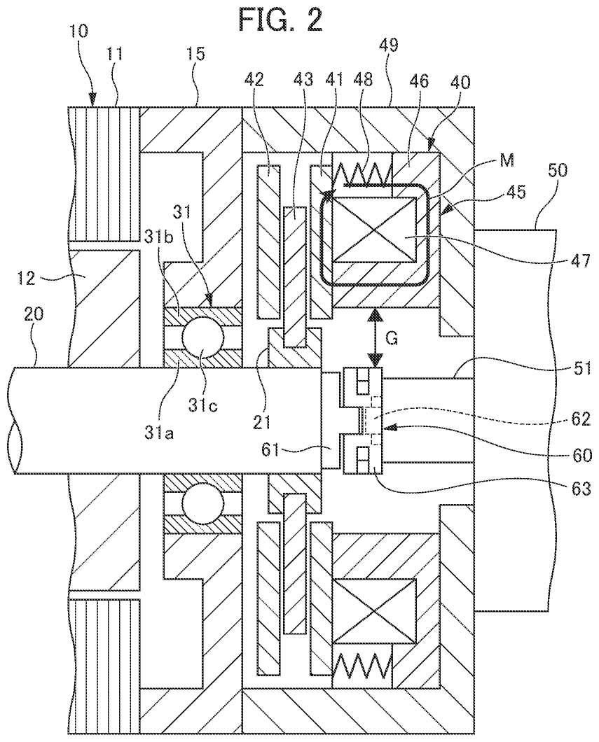

Hereinafter, embodiments of the present disclosure will be described with reference to the drawings. FIG. 1 is a sectional view schematically showing a motor 1 with an electromagnetic brake according to an embodiment of the present disclosure. FIG. 2 is an enlarged view of a portion indicated by II in FIG. 1. The motor 1 with an electromagnetic brake includes a motor 10, a motor shaft 20, a first bearing 31 and a second bearing 32, an electromagnetic brake 40, and an encoder 50. The first bearing 31 is an example of a bearing.

The motor 10 includes a stator 11 and a rotor 12. The stator 11 is a cylindrical member surrounding the rotor 12, and has a structure in which a coil is wound around a stator core formed of a laminate of a large number of electromagnetic steel sheets (all of which are not shown). In the motor 10, a rotating magnetic field is generated by current supplied to the coil, and the rotor 12 rotates in accordance with the rotating magnetic field. A first motor housing 15 and a second motor housing 16 are respectively disposed on both sides of the stator 11 in an axial direction.

The rotor 12 is disposed inside the stator 11. The rotor 12 has a cylindrical shape. The motor shaft 20 is concentrically and integrally provided in the axial center of the rotor 12.

The motor shaft 20 is supported at both end portions by the first bearing 31 provided in the first motor housing 15 and the second bearing 32 provided in the second motor housing 16, and is rotatably supported around the axis. The rotor 12 rotates integrally with the motor shaft 20. The first bearing 31 and the second bearing 32 are, for example, rolling bearings.

Both end portions of the motor shaft 20 project from the first motor housing 15 and the second motor housing 16, respectively. The portion of the motor shaft 20 projecting from the second motor housing 16 serves as an output-side end portion and functions as an output shaft which is directly or indirectly coupled to, for example, a main shaft of a machine tool. In the present embodiment, the motor shaft 20 is a general round bar material, and is made of a magnetic material such as tool steel or structural carbon steel.

The first bearing 31 is disposed in the axial center of the first motor housing 15. The first bearing 31 includes an inner ring 31a, an outer ring 31b, and a plurality of balls 31c provided between the inner ring 31a and the outer ring 31b so as to be capable of rolling. The second bearing 32 is disposed in the axial center of the second motor housing 16. The second bearing 32 includes an inner ring 32a, an outer ring 32b, and a plurality of balls 32c provided between the inner ring 32a and the outer ring 32b so as to be capable of rolling.

The inner ring 31a of the first bearing 31 and the inner ring 32a of the second bearing 32 are fixed to the motor shaft 20. The outer ring 31b of the first bearing 31 is fixed to the first motor housing 15. The outer ring 32b of the second bearing 32 is fixed to the second motor housing 16.

As shown in FIG. 1, in the motor 1 with an electromagnetic brake according to the present embodiment, the second bearing 32, the motor 10, the first bearing 31, the electromagnetic brake 40, and the encoder 50 are arranged in this order from one side to the other side in the axial direction of the motor shaft 20 (from the left side to the right side in FIG. 1). The first bearing 31 is disposed closer to the motor 10 than the electromagnetic brake 40 in the axial direction of the motor shaft 20.

A brake housing 49 is disposed between the first motor housing 15 and the encoder 50. The electromagnetic brake 40 is provided within the brake housing 49. The electromagnetic brake 40 includes an armature 41, an end plate 42, a friction plate (brake rotor) 43 disposed between the armature 41 and the end plate 42, and a brake stator 45. The brake stator 45 includes a brake core 46, a brake coil 47, and a spring 48.

Both the armature 41 and the end plate 42 are annular plate materials. The portion of the motor shaft 20 projecting into the brake housing 49 passes through the centers of the armature 41 and the end plate 42. The armature 41 and the end plate 42 are disposed concentrically with the motor shaft 20. The armature 41 and the end plate 42 are supported by the brake core 46 using support members (not shown). The support members are, for example, a plurality of pins extending in an axial direction (the axial direction of the motor shaft 20) fixed to the brake core 46. The end plate 42 is fixed to the support member. The armature 41 is supported by the support member so as to be movable in the axial direction.

The friction plate 43 is an annular plate material. The inner peripheral portion is fixed to the motor shaft 20 via a flange-shaped coupling portion 21. The friction plate 43 is disposed concentrically with the motor shaft 20. The friction plate 43 rotates integrally with the motor shaft 20. At least portions of both surfaces of the friction plate 43 facing the armature 41 and the end plate 42 are subjected to processing such as brake lining to increase friction.

The brake coil 47 is wound around the brake core 46 having a cylindrical shape, and the brake stator 45 functions as an electromagnet by energizing and exciting the brake coil 47. The spring 48 of the brake stator 45 is, for example, a coil spring, and is built in the brake core 46. The spring 48 is disposed at a portion of the brake core 46 facing the armature 41, and always urges the armature 41 toward the friction plate 43.

When the brake coil 47 is not energized (excited), the spring 48 presses the armature 41 against the friction plate 43, whereby the friction plate 43 is strongly sandwiched between the armature 41 and the end plate 42. As a result, the motor shaft 20 is braked together with the friction plate 43 to be in a brake operation state.

On the other hand, when the brake coil 47 is energized (excited), the armature 41 is attracted to the brake core 46 against the elastic force of the spring 48, and a gap is generated between the armature 41 and the friction plate 43. This releases the friction plate 43, allowing the motor shaft 20 to rotate and the brake to be released. The electromagnetic brake 40 is interlocked with the motor 10. That is, when the motor 10 is operated, the brake coil 47 is energized to release the brake, and the motor shaft 20 rotates. When the operation of the motor 10 is stopped, the energization of the brake coil 47 is stopped, the brake is activated, and the motor shaft 20 is braked.

The encoder 50 detects a rotational position, a rotational speed, and the like of the motor shaft 20. The encoder 50 substantially detects a rotational position, a rotational speed, and the like of an encoder shaft 51 that rotates integrally with the motor shaft 20. The encoder shaft 51 is coupled to the motor shaft 20 via a coupling portion 60. The coupling portion 60 couples the encoder 50 to the motor shaft 20, and transmits the rotation of the motor shaft 20 to the encoder shaft 51. In the present embodiment, the encoder shaft 51 is made of a magnetic material similar to that of the motor shaft 20.

As shown in FIG. 2, the coupling portion 60 of the present embodiment includes an Oldham coupling including a first coupling 61, a second coupling 62, and an Oldham 63. The first coupling 61 is connected to an end portion of the motor shaft 20 facing the encoder shaft 51. The second coupling 62 is connected to an end portion of the encoder shaft 51 facing the motor shaft 20. The Oldham 63 couples the first coupling 61 to the second coupling 62. The coupling portion 60 couples the motor shaft 20 to the encoder shaft 51, allowing them to rotate together while absorbing eccentricity.

As shown in FIG. 2, the axial position of the coupling portion 60 of the present embodiment is superimposed on that of the brake core 46 of the electromagnetic brake 40. That is, the coupling portion 60 is disposed inside the brake core 46. In the present embodiment, the coupling portion 60 is made of a non-magnetic material. For example, the first coupling 61 and the second coupling 62 are made of stainless steel, aluminum, or the like, and the Oldham 63 is made of metal such as stainless steel and aluminum, or a hard resin.

As shown in FIG. 2, in the electromagnetic brake 40, magnetic flux M flows through the brake core 46 during brake operation when the brake coil 47 is energized. On the other hand, among the motor shaft 20, the encoder shaft 51, and the coupling portion 60, the coupling portion 60 is closest to the brake core 46 of the electromagnetic brake 40. In the present embodiment, the shortest distance G between the coupling portion 60 and the brake core 46 is set so as to be separated by A ×0.3 mm or more when the maximum value of the magnetic flux density in the magnetic flux M is A tesla. The specific distance G is, for example, at least 1 mm or more, preferably 5 mm or more. The basis for this is as follows.

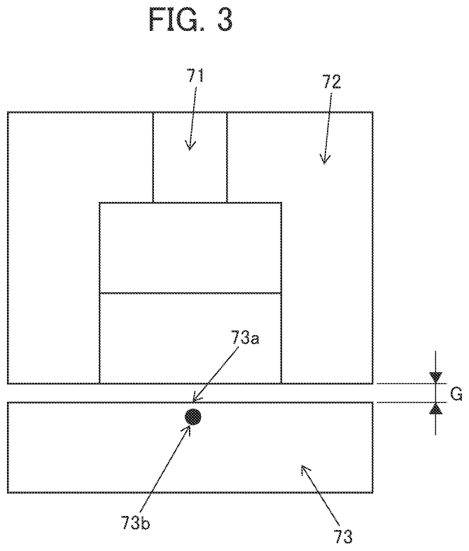

In the embodiment, to confirm how much the magnetic flux flowing through the brake core 46 leaks to the motor shaft 20 side, a simple two-dimensional magnetic circuit shown in FIG. 3 was assumed, and the magnetic field was analyzed. That is, certain magnetic flux was flowed from a magnet 71 having a magnetic flux density of 1.3 to iron 72 imitating the brake core 46 of the electromagnetic brake 40, using the magnetic circuit shown in FIG. 3, and it was confirmed how much the magnetic flux leaked to iron 73 assumed to be the motor shaft 20. Both the iron 72 and the iron 73 were a carbon steel for machine structural use (S45C). The distance G between the iron 72 and the iron 73 was varied to measure the magnetic flux density at the measuring point 73b 2 mm deep from the edge 73a in the iron 73, and the magnetic flux lines were examined.

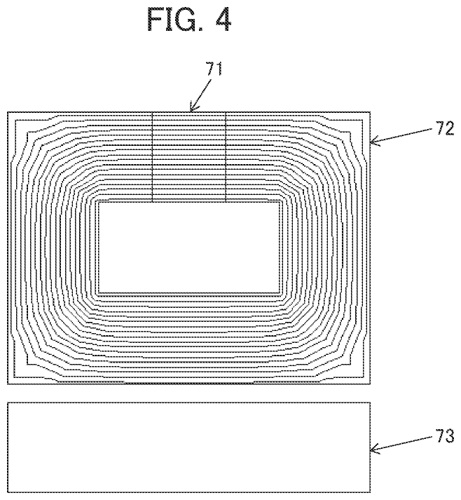

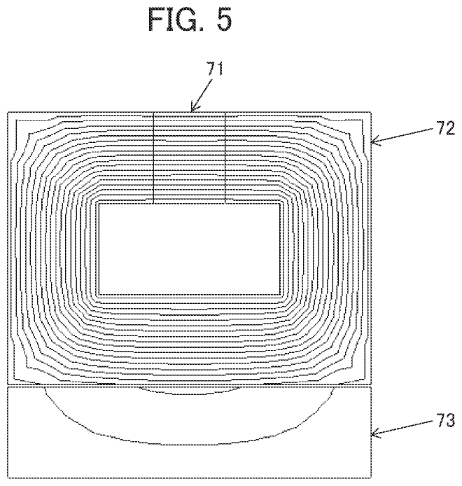

FIG. 4 shows a state of magnetic flux lines flowing through the iron 72 when the distance (inter-axis distance) G between the iron 72 and the iron 73 is 2 mm. In this case, it was confirmed that there was almost no leakage of magnetic flux. FIG. 5 shows a state of magnetic flux lines flowing through the iron 72 when the distance G between the iron 72 and the iron 73 shown in FIG. 3 is 0.2 mm. In this case, it was confirmed that magnetic flux was flowing through the iron 73 and leakage magnetic flux was occurring.

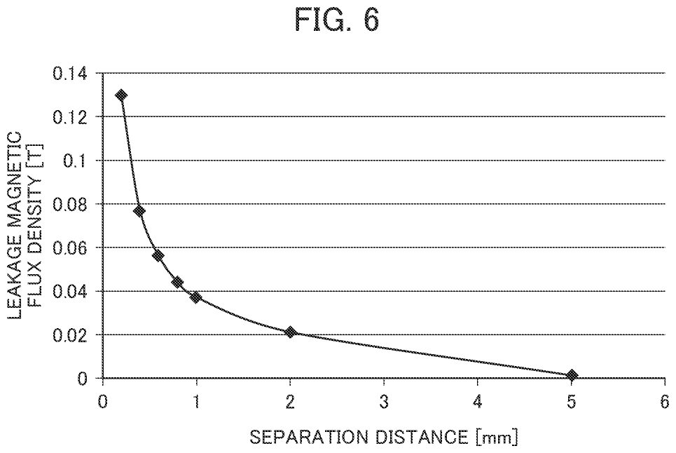

FIG. 6 shows the measurement results of the leakage magnetic flux density [T (tesla)] at the measurement point 72b in the case in which the distance G between the iron 72 and the iron 73 was 0.2 mm, 0.4 mm, 0.6 mm, 0.8 mm, 1.0 mm, 2.0 mm, or 5.0 mm. According to FIG. 6, when the distance G was 0.2 mm, the leakage magnetic flux density shows a leakage magnetic flux density of 0.13 T, which is 10% of the magnetic flux density of 1.3 T of the magnet 71, whereas when the distance G was 1 mm, the leakage magnetic flux density could be reduced to 0.037 T. Further, when the distance G was 5 mm, the leakage magnetic flux density could be reduced to 0.001 T. Accordingly, the distance G between the coupling portion 60 and the brake core 46 shown in FIG. 2 needs to be 1 mm or more, preferably 5 mm or more.

As described above, in the present embodiment, among the motor shaft 20, the encoder shaft 51, and the coupling portion 60, the shortest distance G between the coupling portion 60, which is closest to the brake core 46 of the electromagnetic brake 40, and the brake core 46 is A ×0.3 mm or more. Accordingly, the distance between the motor shaft 20 and the brake core 46 and the distance between the encoder shaft 51 and the brake core 46 are both A ×0.3 mm or more.

According to the motor 1 with an electromagnetic brake according to the present embodiment described above, the first bearing 31 is disposed closer to the motor 10 than the electromagnetic brake 40 in the axial direction of the motor shaft 20. When the maximum value of the magnetic flux density in the magnetic flux flowing through the brake core 46 of the electromagnetic brake 40 is A tesla, the brake core 46, which is a portion of the electromagnetic brake 40 through which the magnetic flux flows, and the motor shaft 20 are arranged apart from each other by A ×0.3 mm or more.

This makes it difficult for magnetic flux to flow from the brake core 46 of the electromagnetic brake 40 via the first bearing 31, even if the motor shaft 20 is made of a magnetic material. Further, even if a part of the motor shaft 20 is not made of a non-magnetic material, it is difficult for magnetic flux to flow through the motor shaft 20. Therefore, it is possible to easily suppress adhesion of metal powder to the motor shaft 20 while minimizing cost.

In the motor 1 with an electromagnetic brake according to the present embodiment, the encoder 50 is connected to the motor shaft 20 via the encoder shaft 51, and the brake core 46, which is a portion of the electromagnetic brake 40 through which magnetic flux flows, and the encoder shaft 51 are arranged apart from each other by A×0.3 mm or more. As described above, A is the maximum value of the magnetic flux density in the magnetic flux M flowing through the brake core 46.

This makes it difficult for magnetic flux to flow through the encoder shaft 51 even if the encoder shaft 51 is not made of a non-magnetic material. As a result, it is possible to easily suppress adhesion of metal powder to the encoder shaft 51 while minimizing cost.

In the motor 1 with an electromagnetic brake according to the present embodiment, the encoder shaft 51 is coupled to the motor shaft 20 via the coupling portion 60. The brake core 46, which is a portion of the electromagnetic brake 40 through which magnetic flux flows, and the coupling portion 60 are arranged apart from each other by A ×0.3 mm or more. As described above, A is the maximum value of the magnetic flux density in the magnetic flux M flowing through the brake core 46.

This makes it difficult for magnetic flux to flow through the coupling portion 60, and thus, it is possible to easily suppress adhesion of metal powder to the coupling portion 60 while minimizing cost. In the present embodiment, since the coupling portion 60 is made of a non-magnetic material, magnetic flux is less likely to flow through the coupling portion 60. As a result, adhesion of metal powder to the coupling portion 60 can be more effectively suppressed.

The present disclosure is not limited to the above-described embodiments, and can be modified as appropriate. For example, although the coupling portion 60 is closest to the brake core 46 among the motor shaft 20, the encoder shaft 51, and the coupling portion 60 in the above embodiment, the present invention is not limited thereto. The motor shaft 20 or the encoder shaft 51 may be closest to the brake core 46. Alternatively, the motor shaft 20 may extend to the encoder 50, and the encoder 50 may directly detect the rotation of the motor shaft 20.

### EXPLANATION OF REFERENCE NUMERALS

1 motor with electromagnetic brake
10 motor
20 motor shaft
31 first bearing (bearing)
40 electromagnetic brake
50 encoder
51 encoder shaft
60 coupling portion

1. A motor with an electromagnetic brake, comprising:
a motor;
a motor shaft configured to be rotated by the motor;
a bearing configured to rotatably support the motor shaft;
an electromagnetic brake configured to brake rotation of the motor; and
an encoder configured to measure a rotation angle of the motor, wherein
the bearing is arranged closer to the motor than the electromagnetic brake in an axial direction of the motor shaft, and
when a maximum value of a magnetic flux density in magnetic flux flowing through the electromagnetic brake is A tesla, a portion of the electromagnetic brake through which the magnetic flux flows and the motor shaft are arranged apart from each other by A ×0.3 mm or more.

2. The motor with an electromagnetic brake according to claim 1,
wherein the encoder is connected to the motor shaft via an encoder shaft, and
the portion of the electromagnetic brake through which the magnetic flux flows and the encoder shaft are arranged apart from each other by A ×0.3 mm or more.

3. The motor with an electromagnetic brake according to claim 2,
wherein the encoder shaft is coupled to the motor shaft via a coupling portion, and
the portion of the electromagnetic brake through which the magnetic flux flows and the coupling portion are arranged apart from each other by A ×0.3 mm or more.

4. The motor with an electromagnetic brake according to claim 3, wherein the coupling portion is made of a non-magnetic material.
